(19) United States
(12) Patent Application Publication
(10) Pub. No.: US 2015/0083168 A1
(43) Pub. Date: Mar. 26, 2015

(54) LIQUID SOLVENT SPRAY BRUSH STATION FOR SURFACE CLEANING IN NANO-MICROTRONICS PROCESSING

(71) Applicant: US Gov't represented by Secretary of the Navy Chief of Naval Research ONR/NRL, Arlington, VA (US)

(72) Inventors: Adam L. Friedman, Silver Spring, MD (US); David W. Zapotok, Edgewater, MD (US)

(73) Assignee: US Gov't represented by Secretary of the Navy Chief of Naval Research ONR/NRL, Arlington, VA (US)

(21) Appl. No.: 14/245,517

(22) Filed: Apr. 4, 2014

Related U.S. Application Data
(60) Provisional application No. 61/880,942, filed on Sep. 22, 2013.

(51) Int. Cl. B08B 3/02

(52) U.S. Cl. CPC B08B 3/026
USPC 134/102.2

(57) ABSTRACT

A medium strength, liquid solvent, spray brush station system gently cleans surfaces of components during nano- and microtronics processing in cleanroom facilities. This system includes intermediate strength, yet effective surface cleaning with minimal damage to subject nano and microtronics components. Moreover, the instrument is compatible with a cleanroom environment, and provides self contained, easily manageable disposition of the peripheral mess and waste resulting from the cleaning process.

### RELATED APPLICATIONS

The instant U.S. patent application claims the benefit of domestic priority from and is related to U.S. Provisional Patent Application No. 61/880,942; LIQUID SOLVENT SPRAY BRUSH STATION SURFACE CLEANING IN NANO-MICROTRONICS PROCESSING; Docket Number 102623; filed on Sep. 22, 2013; whose inventors are Adam L. Friedman and David W. Zapotok; and where said U.S. Provisional Patent Application is herein incorporated by reference in its entirety.

### FIELD OF THE INVENTION

The present invention is generally related to nanotechnology and microtechnology fabrication and processing. In particular the present invention comprises a medium strength, liquid solvent, air/gas-brush spray station used for cleaning electronic devices, components, circuit elements, or surfaces during nanotechnology and microtechnology (hereafter nanotronics and microtronics) device processing. This medium strength, liquid solvent, air/gas-brush spray station includes intermediate strength, yet effective surface cleaning with minimal damage to the subject nanotronics and microtronics components; and the cleaning station is inexpensive to assemble and it is also compatible with a clean room facility.

### BACKGROUND OF THE INVENTION

Nanotronics and microtronics components are composed of nanoscale and microscale elements, not visible to the human eye, where nanoscale is smaller than a micron, while microscale is smaller than 1 milimeter, still too small for the human eye to see without a compound light microscope (see FIG. 5B including thumbnail inset); in other words, nanoscale electronics are electronics on the order of nanometers (1-1000 nm), while microscale electronics are on the order of microns (1-1000 microns). When fabricating samples and devices for nanotronics and microtronics elements, it is necessary to clean the surfaces between steps and before mechanical or electronic testing of the devices.

Nano- and microtronics device/component surface cleaning falls in at least two categories: (I) gentle methods and (II) strong methods. For gentle methods, cleaning is usually accomplished by slightly agitating a sample immersed in a solvent bath, or by gently rinsing a sample in solvent. Gentle methods are not effective at removing strongly adhering particles and impurities. For strong methods, immersion in ultrasonic baths is one widely adopted method. Ultrasonic baths where a sample is cleaned by high frequency sound waves distributed in a liquid bath, are readily available in the marketplace from a variety of vendors. However, ultrasonic baths often unintentionally damage wanted surface features. Mechanical cleaning is another strong cleaning method, whereby the surface is wiped using a specially designed cloth or similar tool. Mechanical cleaning is quite effective at removing surface impurities. However, it will damage more delicate surface features. Acid baths are commonly used for surface cleaning. However, the impurities must be susceptible to dissolution in acid for this method to be effective. Acid baths often leave unintended damage to surfaces, thus acid baths are incompatible or ineffective with a wide range of surfaces, and the acid bath surface cleaning methods present real danger of bodily harm to users.

Nano- and microtronics device/component cleaning is usually accomplished using very gentle methods such as solvent rinses, or using very harsh methods such as immersion in an ultrasonic bath, acid bath or by mechanical cleaning, as discussed above. While gentle solvent rinses can be effective for impurities and dirt adhering weakly to surfaces, simple rinsing does not remove more stubborn particles. For instance, when conducting a metal/photoresist lift-off cleaning process, it can take hours of solvent baths and gentle rinsing to remove unwanted material. Oftentimes, one is unable to remove excess metals completely. Additionally, immersion in an ultrasonic bath, acid bath, or mechanical cleaning can effectively and quickly remove dirt and impurities from a surface. However, it often unintentionally damages nanoscale or microscale features on a surface. There currently are no medium-strength methods of surface cleaning for nano- and microtronics processing in the marketplace today. The features of such a method or instrument would include gentle, yet effective surface cleaning with minimal damage. Moreover, as the instrument must be compatible with a cleanroom environment, the peripheral mess and waste left by the process must be self-contained and easily managed. This invention disclosure describes an invention that accomplishes the above goals, and furthermore, this cleaning station is self-contained and small enough to fit on a desktop.

### SUMMARY OF THE INVENTION

Exemplary embodiments describe an inexpensive, medium strength, liquid solvent, air/gas-brush spray station used in cleaning electronic devices, components, circuit elements, or surfaces during nano- and microtronics processing compatible with a clean room facility. This instrument includes gentle, yet effective surface cleaning with minimal damage to subject nano- and microtronics components. Moreover, as the instrument must be compatible with a clean room environment, it provides self-contained, easily manageable disposition of the peripheral mess and waste left by the cleaning process.

### BRIEF DESCRIPTION OF THE DRAWINGS

FIG. 1 illustrates a schematic diagram of the liquid solvent, air/gas-brush spray station from a top down perspective.

FIG. 2A illustrates some components of the liquid solvent, air/gas-brush spray station including: a glove box, rubber glove access ports, waste drain, support legs, hinged access port and viewing window, fume hood vent, and the solenoid/vacuum assemblies.

FIG. 2B illustrates additional components of the liquid solvent, air/gas-brush spray station, including: a hinged access port closed; one can see the solvent reservoir inside the box and a reflection from the replaceable clear plastic solvent shield.

FIG. 3A illustrates components of the liquid solvent, air/gas-brush spray station including: a Nitrogen line connection, a solenoid valve, a vacuum line connection, and a pressure regulator.

FIG. 3B illustrates a solenoid valve foot pedal energizer, along with different views of the Nitrogen line connection, and the pressure regulator.

FIG. 4 illustrates the inside of the instrument glove box.

FIG. 5A illustrates a subject nano-microtronics device and/or component immediately after metals deposition, i.e., before using the liquid solvent, air/gas-brush spray station to perform excess metal lift-off cleaning on the microscale electronic devices and surface elements.

FIG. 5B illustrates the same device referred to in the brief description of FIG. 5A, after cleaning with the liquid solvent, air/gas-brush spray station.

### DETAILED DESCRIPTION OF THE INVENTION

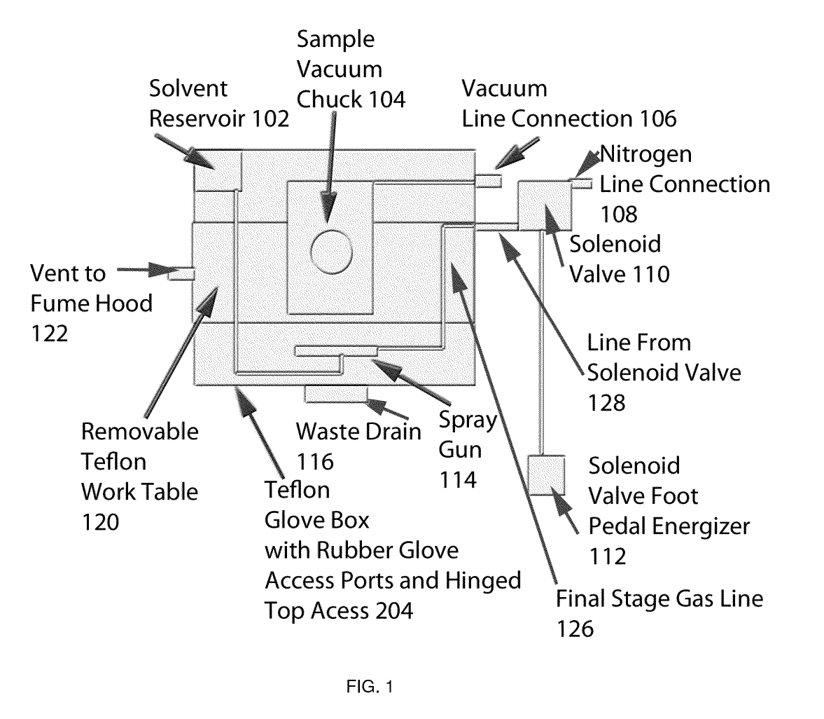

FIG. 1 illustrates a schematic diagram of the liquid solvent, air/gas-brush spray station from a top down perspective. The outside of the instrument is a solvent compatible (i.e., chemical and solvent resistant) TEFLON® glove box with two ports for rubber gloves for sample manipulations inside the glove box space and a hinged clear plastic access port and viewing window with replaceable clear plastic spray shield on top of the box, where TEFLON is a plastic also known as Polytetrafluoroethylene (PTFE). The box also has a gas vent for proper fume hood gas venting. The bottom of the box is conically shaped and fitted with a liquid waste drain. The box also has a port for a vacuum line connection 106 to connect a vacuum line with an aluminum sample stage and vacuum chuck 104, which is inside the box. Next to the vacuum line, on the outside of the glove box 118, is a nitrogen line connection 108, regulated by a foot pedal activated solenoid valve 110 and a pressure regulator 302. This nitrogen line leads to the air/gas-brush spray (also known as a “spray gun 114”) located inside the glove box 118. Furthermore, inside the glove box 118, the spray gun 114 is also connected to a solvent reservoir 102, which is easily refillable with any desired solvent. The sample vacuum chuck 104 sits on a removable TEFLON stage (also known as “the removable TEFLON work-table 120”) over the sample waste drain 116. The removable TEFLON work-table 120 facilitates cleaning of the inside of the instrument. The entire instrument is made with space-saving considerations in mind and is fit inside a TEFLON glove box 118, which sits on a table. In exemplary embodiments, TEFLON is the material of choice for the glove box 118 due to the ability of TEFLON to withstand a wide variety of chemical solvents, acids, and bases; however, other solvent and chemical resistant plastics may also be used.

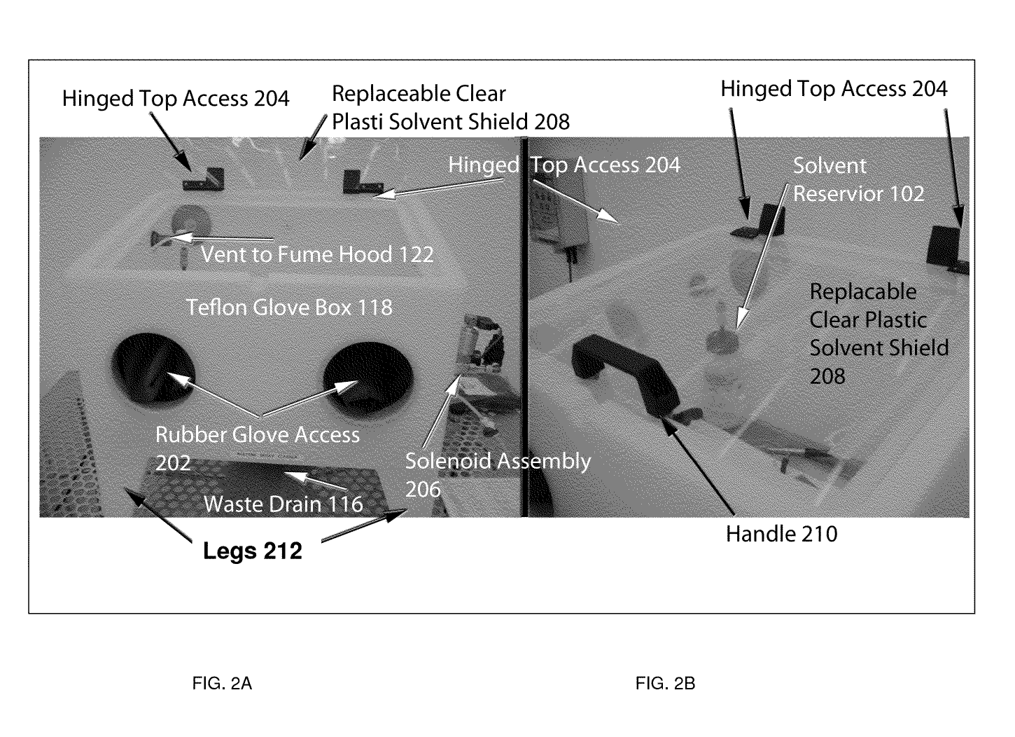

The outside of the glove box 118 is illustrated in FIG. 2A and FIG. 2B, where FIG. 2A illustrates the components of the liquid solvent, air/gas-brush spray station including: the glove box 118, rubber glove access ports 202, waste drain 116, legs 212, hinged top access 204 port and viewing window, (covered with the replaceable clear plastic solvent shield 208), fume hood vent 122, and the solenoid/vacuum assemblies. FIG. 2B illustrates the liquid solvent reservoir 102, air/gas-brush spray station components including: a hinged top access 204 port closed. One can see the solvent reservoir 102 inside the glove box 118 and a reflection from the replaceable clear plastic solvent shield 208.

Referring to FIG. 2A and FIG. 2B, the glove box 118 has rubber glove access ports 202 used to manipulate the sample inside the glove box 118. For sample loading, there is at least a hinged top access 204 port on top of the glove box 118. A replaceable clear plastic solvent shield 208 adheres to the bottom side of the hinged top access 204 port. Because the access port doubles as a viewing window (also known as the replaceable clear plastic solvent shield 208 during instrument operation, it must be protected from solvent damage. The window of the port is made of clear plastic that can become damaged when contacted by certain chemicals. The replaceable clear plastic solvent shield 208 protects the window and can be easily replaced after use as often as is required. The waste drain 116 is a funnel shaped or conical shaped TEFLON bottom of the glove box 118, that contains an outlet port for the chemical and sample waste to be collected and properly disposed; the waste drain 116 is elevated and supported above a desktop surface by legs 212. In FIG. 2A, the glove box 118 includes the fume hood vent 122 that vents gas and vapor to a fume hood. The fume hood vent 122 connects the inside of the glove box 118 to a fume hood for proper chemical fume disposal. The outside right part of the glove box 118 contains the nitrogen line connection 108 and vacuum line connection 106 inlets and the solenoid/pressure gauge valves.

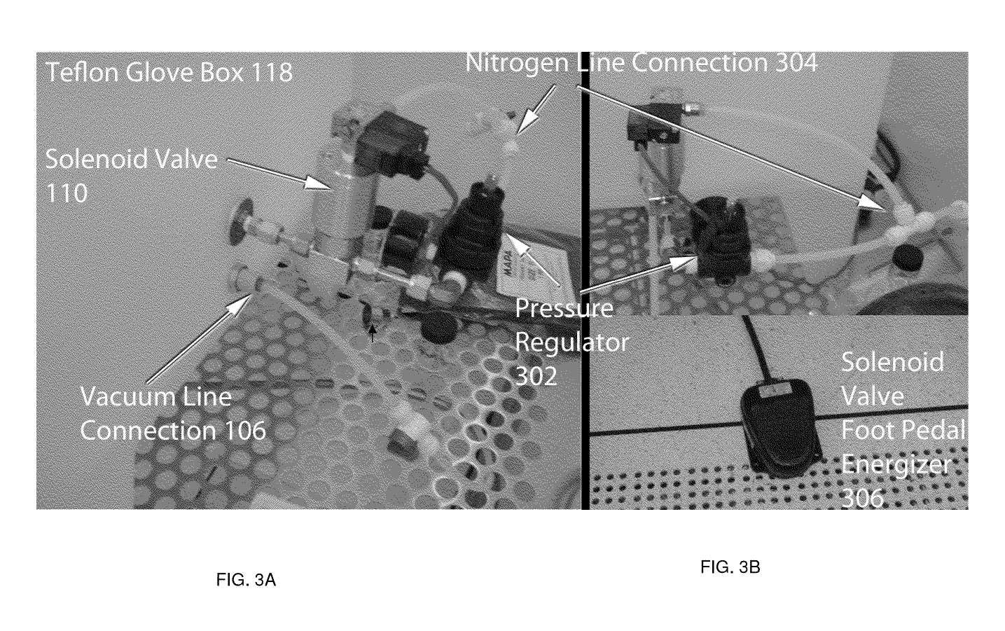

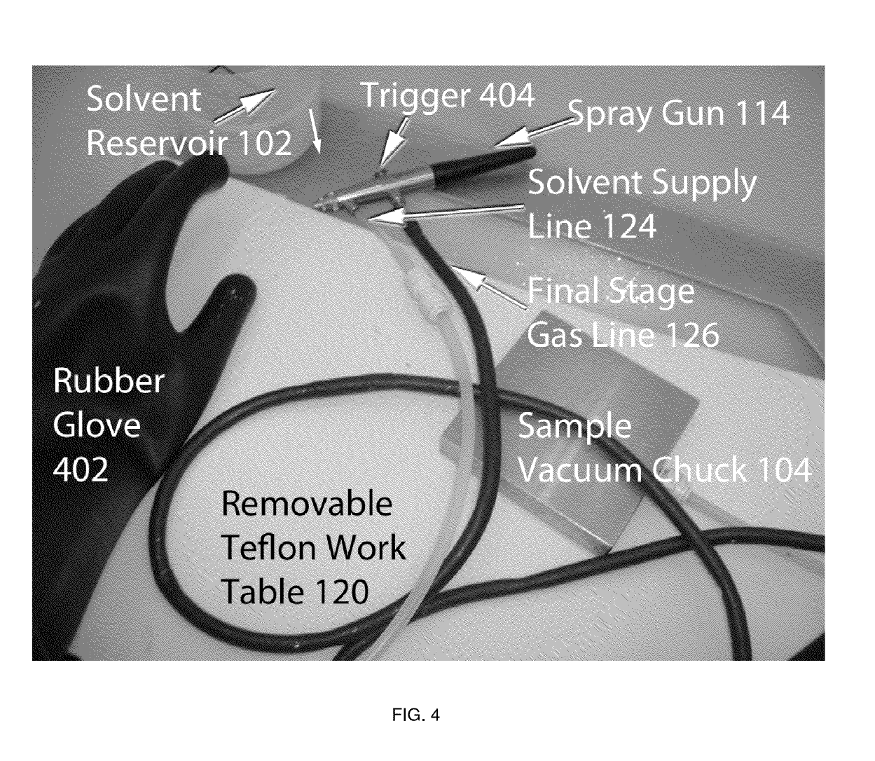

Referring to FIG. 4, FIGS. 3A and 3B: FIG. 3A illustrates components of the liquid solvent, air/gas-brush spray station including: the Nitrogen line connection 108, the solenoid valve 110, the vacuum line connection 106, and a pressure regulator 302. FIG. 3B illustrates a solenoid valve foot pedal energizer 306, along with different views of the Nitrogen line connection 304, and the pressure regulator 302. In FIG. 3A and FIG. 3B, the different views of the vacuum line connection 106 show connection to the sample vacuum chuck 104 inside of the glove box 118, which is illustrated in FIG. 4. Vacuum can be switched on and off by means of a simple valve switch attached to the vacuum line. The solenoid valve 110, powered by a one hundred ten volt (110 volt) foot pedal switch (such as solenoid valve foot pedal energizer 306), turns on/off the flow of nitrogen gas to the spray brush (such as spray gun 114) and is regulated by a pressure regulator 302 set in a predetermined setting in a range from about 0 psi up to about 20 psi. The solenoid assembly is connected directly to the spray gun 114 inside of the glove box 118. The inside of the glove box 118 is shown in FIG. 4.

Referring to FIG. 4, the aluminum sample vacuum chuck 104, which sits on the removable TEFLON stage 120, is attached to the vacuum line connection 106 inlet. The spray gun 114 has a solvent supply line 124 attachments to the solvent reservoir 102 and the spray gun 114 further has attachments to the nitrogen line connection 304 inlet (controlled by the solenoid/pressure regulator assembly). Rubber glove(s) 402 from the glove access ports 202 is/are visible and are used to manipulate the sample components and spray gun 114, when the hinged top access 204 port is closed.

Again referring to FIG. 4, in the upper left corner of FIG. 4, the solvent reservoir 102 which if refillable is illustrated. The liquid solvent supply line 124 is connected using a quick connect fitting from the solvent reservoir 102 to the spray gun 114. The spray gun 114 is also connected to a nitrogen connection line connection 108 coming in from the solenoid valve 110/pressure regulator 302 assembly. The spray gun 114 is a repurposed commercially available airbrush usually used for painting applications. The paint reservoirs are removed and replaced with a chemical solvent reservoir 102 and gas lines. The solvent supply line 124 can use vacuum action causing the solvent to flow from the solvent reservoir 102 through the small capillary-like solvent supply line 124 to the spray gun 114. The spray gun 114 has a trigger 404 that when depressed simultaneously with the solenoid valve pedal energizer 112 causes the pressurized nitrogen gas (or Oxygen or other gases, including compressed air gases) to mix with a selected solvent and sprays solvent at a range of low to medium pressures, from a rotateably adjustable nozzle attached to the spray gun 114, onto the sample. According to exemplary embodiments, the solvent droplet size and strength are adjustable based on nozzle adjustments and gas pressure adjustments. Furthermore, the definition of “medium” strength cleaning of nanotronics and microtronics devices is related to ejected solvent droplet sizes and a measure of cleaning efficiency. By using different swappable nozzle tip sizes, to obtain a range of solvent droplet sizes, from small size droplets to larger size droplets, the cleaning efficiency for any particular nanotronics and/or microtronics device, element or component needing cleaning, can be customized. Any given nozzle determines the amount of spray applied to an area, how uniform the spray application is, and the amount of coverage obtained on a target surface. Nozzles break the solvent into droplets, form a spray pattern and propel the droplets in a direction and a nozzle discharge spray volume measured in gallons per minute (GPM) onto a device surface. According to Petersen D. (TEEJET TECHNOLOGIES, 2013, page 22, Oregon State University Internet [http://www.ipmnet.org/timpesticide_ed/Pesticied_Courses_-_{—}2013/Chem_App/Dugan_Peterson-Spray_Tips,_Droplet_Size_and_Calibration.pdf] (Accessed Apr. 1, 2014)) droplets are characterized in terms of a measure of volume median diameter expressed as D(v0.5); thus based on a volume median diameter standard of D(vo.5), a small droplet can be characterized as D(v0.1) and a large droplet can be expressed as (Dv0.9) in relation to the volume median diameter (VMD) of D(v0.5). Thus, according to exemplary embodiments, for very small device features, smaller droplets will provide for more efficient cleaning, as compared to larger nanotronics and/or microtronics device features, where the larger droplet particles will provide for an efficient cleaning with less collateral damage of those larger nanotronics and/or microtronics device features. In other words, smaller particles can get into smaller crevices, where larger particles cannot; and larger droplets are more suitable for cleaning larger surfaces, where the larger surfaces have fewer small crevices; thus, the smaller droplets are more efficient in cleaning smaller surfaces with smaller crevices and larger droplets are more efficient in cleaning larger surfaces with few small crevices. Also, by adjusting the pressure regulator 302 setting from about 0 PSI up to about 20 PSI, one can obtain a range of medium spray mist strengths from low strength, i.e., corresponding to near 0 PSI to an intermediate spray mist strength and up to a relatively higher spray mist strength setting of about 20 PSI: The sample is placed on the aluminum sample vacuum chuck 104 pictured in FIG. 4 and FIG. 1. This keeps the sample in place during cleaning. A removable TEFLON work-table 120 stage sits directly over the waste drain 116 on the bottom of the inside of the glove box 118, allowing for easy cleaning of the inside of the glove box 118 after using the liquid solvent air/gas-brush spray station.

Operation of the liquid solvent spray air/gas-brush spray station: Referring to FIG. 2A, FIG. 2B, FIG. 3A, FIG. 3B and FIG. 4, an operator opens the hinged top access 204 port and positions a sample on the sample vacuum chuck 104. The vacuum is then turned on, which holds the sample in place by the suction force of the vacuum. The solvent reservoir 102 is then filled with a selected chemical solvent to perform the cleaning. The top access port is closed and the operator, with hands positioned in the rubber gloves 402 accessed through the rubber glove access 202 ports, grips the spray gun 114 and positions the spray gun 114 over the sample component and/or device. The operator then simultaneously pushes the trigger 404 of the spray gun 114, engaging the spray gun 114 and steps on the solenoid valve foot pedal energizer 112. The spray gun 114 emits a fine, adjustable, mist like-spray, of solvent mixed with nitrogen gas that cleans the sample. Waste solvent is automatically collected in the glove box 118 waste drain 116. When the sample is clean, the operator removes the sample through the hinged top access 204 port. The operator can also remove and clean the removable TEFLON stage to keep the glove box 118 clean and the operator can also replace the replaceable clear plastic shield 208 that protects the top access port window, if necessary.

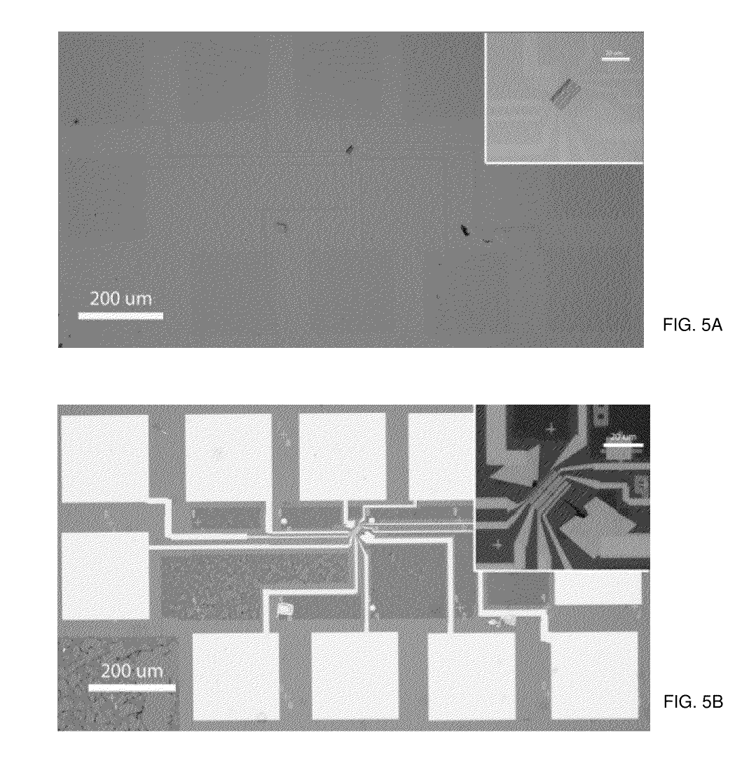

FIG. 5A and FIG. 5B illustrate before and after images (respectively) of a microscale electronic circuit device/component cleaned with the liquid solvent air/gas-brush spray station. The before image (FIG. 5A) shows the device immediately after deposition of a layer of metal following a lithographic processing operation. The device is surrounded by excess metal. The thumbnail inset in FIG. 5A shows a close-up image of the fragile, active part of the device, which is located near the center of the electronic circuit device, illustrated in FIG. 5A. The after image (FIG. 5B) shows the device/component after having been cleaned in the liquid solvent air/gas-brush spray station where the excess metal has been removed. The thumbnail inset in FIG. 5B shows a close-up of the same fragile active region of the device/component. It can be seen that the excess metal has been removed without damaging the fragile portions of the device, located near the center of the electronic circuit device, illustrated in FIG. 5B. If this same cleaning procedure were attempted with harsher methods, such as wiping or immersion in an ultrasonic bath, the fragile parts of the device would also have been removed. It would not be possible to remove this metal with acid or plasmas etchings, because of damage to the substrate. Moreover, gentler cleaning methods, such as solvent rinsing, are not powerful enough to remove the excess metal.

The foregoing description of the specific embodiments will so fully reveal the general nature of the invention that others can, by applying knowledge within the art, readily modify and/or adapt for various applications such specific embodiments, without undue experimentation, without departing from the general concept of the present invention. Therefore, such adaptations and modifications are intended to be within the meaning and range of equivalents of the disclosed embodiments claimed herein and below, based on the teaching and guidance presented herein and the claims which follow:

What is claimed is:

1. An electronic device, element and surface cleaning station apparatus having regulated, adjustable gas pressure cleaning components and regulated, adjustable chemical spray cleaning components; the cleaning station apparatus comprising:
a glove box, having a first and a second rubber glove access ports; wherein a first rubber glove and a second rubber glove reside in and are attached to the first and the second rubber glove access ports, wherein the glove box is composed of solvent and chemical resistant plastic, and wherein the first rubber glove and the second rubber glove have solvent and chemical resistance properties, wherein a user having hands in the first and second rubber gloves has protection from chemical and solvent exposure, during the user manipulation and cleaning of electronic devices, elements and surfaces in the cleaning station apparatus, wherein electronic devices and elements having surfaces include nanotronics and microtronics components;
a hinged top access port, having two hinges pivotally connected between a top surface of the cleaning station apparatus, and a replaceable clear plastic viewing window having a handle on the top surface of the replaceable clear plastic viewing window; wherein the replaceable clear plastic viewing window further includes a clear plastic solvent shield replaceably adhered to the bottom of the replaceable clear plastic viewing window;
a waste drain, residing at the bottom of the glove box, between the first and second rubber glove access ports, wherein the glove box and the waste drain are on a side of the cleaning station apparatus;
a fume hood vent having a vent connection to a fume hood;
a plastic work table removably positioned in the cleaning station apparatus;
a sample vacuum chuck assembly, residing on the plastic work table, wherein the sample vacuum chuck assembly includes a connection to a vacuum line;
a solenoid assembly, having an adjustably opened and closed solenoid valve, wherein the solenoid assembly is activatively attached to a foot pedal energizer, wherein the solenoid assembly has an activatively coupled input gas port connected to an input gas line connection having a gas supply, wherein the gas supply is selected from a group of gas supplies, consisting of at least Nitrogen gas, Oxygen gas and compressed air gas; wherein the solenoid assembly further includes an output gas port connected to an intermediate stage output gas line;
an adjustable gas pressure regulator is connected between the intermediated stage output gas line and a final stage output gas line;
a refillable solvent reservoir, containing solvent, residing in the glove box, having a solvent output port connection to a solvent supply line; and
a spray gun having an actuating trigger, a rotateably adjustable nozzle, a first input port, and a second input port, and an output port; wherein the solvent supply line includes a connection to the first input port of the spray gun, wherein the final stage output gas line includes a connection to the second input port of the spray gun, wherein the adjustably opened and closed solenoid valve having a regulated range of gas fluid flow from a fully open position of the solenoid valve to a fully closed position of the solenoid valve, upon actuation, by a human operator, of the foot pedal energizer, depending on a force applied to the foot pedal energizer by the operator and depending on a setting of the adjustable gas pressure regulator; and the spray gun further having an adjustable spray of solvent mixed with pressurized gas upon depressing, by the human operator, the actuating trigger in coordination with actuation of the foot pedal energizer connected to the solenoid valve, in association with a predetermined setting of the adjustable gas pressure regulator.

2. The cleaning station apparatus according to claim 1, further including different swappable nozzle tip sizes, wherein a spray droplet size is adjustable depending on which swappable nozzle tip size is installed on the spray gun, wherein the droplet size is selected from a group of droplet sizes consisting of small and large.

3. The cleaning station apparatus according to claim 1, wherein the adjustable gas pressure regulator has a setting ranging from about zero pounds per square inch up to about twenty pounds per square inch of pressure, and wherein the cleaning station apparatus thus has a regulated medium strength gas pressure, non-invasive, solvent spray and cleans adhering particles, excess metals, and impurities from nanotronics and microtronics components, and maintains delicate component element structures and surface features on nanotronics and microtronics components.

4. The cleaning station apparatus according to claim 1, wherein the cleaning station apparatus is self-contained and small enough to fit on a desktop, and includes clean room compatible waste and containment components.

5. An electronic device and surface cleaning station process having regulated, adjustable gas pressure and regulated, adjustable chemical sprays; the electronic device and surface cleaning station process comprising:
opening, by an operator, a hinged top access port of an electronic device and surface cleaning station;
filing, with a selected chemical solvent, by the operator, a refillable solvent reservoir residing in the electronic device and surface cleaning station;
positioning, by the operator, a sample electronic device having surfaces on a sample vacuum chuck assembly residing within the electronic device and surface cleaning station;
turning on a vacuum supply, placing suction force on the sample electronic device having surfaces, holding the sample electronic device having surfaces in place on the sample vacuum chuck assembly;
closing the hinged top access port of the electronic device and surface cleaning station;
inserting, by the operator, a first hand of the operator into a first rubber glove and inserting by the operator a second hand of the operator into a second rubber glove residing in and attached to a first and second rubber glove access port within the electronic device and surface cleaning station, wherein the first and second rubber gloves have solvent and chemical resistant properties and thus the first and the second hand of the operator are protected from solvent and chemical exposure, while manipulating and cleaning electronic device having surfaces in the electronic device and surface cleaning station; by
gripping, with the first hand of the operator, a spray gun residing in the electronic device and surface cleaning station, wherein the spray gun is connected to a final stage gas line regulated by an adjustable gas pressure regulator, wherein the spray gun is also connected to a solvent supply line, and wherein the spray gun has a trigger;
simultaneously actuating, by the operator, the trigger of the spray gun and a solenoid valve foot peddle energizer connected to the final stage gas line through a solenoid valve, causing emitting of a spray solvent mixing with pressurized gas;
adjusting, by the operator, the adjustable gas pressure regulator causing a regulated range of medium gas pressure from a group of gas pressures consisting of a low strength, an intermediate strength, and a higher strength gas pressure;
changing, by the second hand of the operator, a position of the sample electronic device having surfaces, while the spray solvent mixing with pressurized gas flows over the sample electronic device having surfaces removing strongly adhering surface particles, impurities, dirt, unwanted photo-resist residue, excess metal from lithographic processing, leaving wanted delicate component element structures and wanted surface features of the sample electronic device having surfaces free from substrate damage, and free from mechanical cleaning damage;
draining and collecting, automatically, waste solvent including surface particles, impurities, dirt, unwanted photo-resist residue, excess metal from lithographic processing, in a waste drain of the electronic device and surface cleaning station; and
venting accumulating fumes generated during cleaning of the sample electronic device having surfaces within the cleaning station.

6. The cleaning station process according to claim 5, wherein the adjustable gas pressure regulator has settings ranging from about zero pounds per square inch up to about twenty pounds per square inch of pressure, causing the regulated range of gas pressure from the group of gas pressures consisting of low strength or intermediate strength or medium strength gas pressure, non-invasive, solvent spray cleaning of adhering particles, excess metals, and impurities from nanotronics and microtronics devices and elements having surfaces, and maintaining delicate device and element structures and surface features on nanotronics and microtronics components.

7. The cleaning station process according to claim 5, wherein the cleaning station process is self-contained in the electronic device and surface cleaning station, which is small enough to fit on a desktop, and is compatible with clean room waste and containment requirements.

8. The cleaning station process according to claim 5, further including, upon completing cleaning of the sample electronic device having surfaces by the operator, opening the hinged top access port of the electronic device and surface cleaning station apparatus and removing the sample electronic device having surfaces from the electronic device and surface cleaning station apparatus.

9. The cleaning station process according to claim 5, further including replacing, by the operator, a clear plastic shield protecting a top access port window of the electronic device and surface cleaning station apparatus.

10. The cleaning station process according to claim 5, further including removing and cleaning, by the operator, a removable plastic work table.

11. The cleaning station process according to claim 5, further including changing, by the operator, swappable nozzle tips having different sizes on the spray gun, wherein a spray droplet size is adjustable depending on which swappable nozzle tip size is changed on the spray gun, wherein changing swappable nozzle tips along with adjusting the adjustable gas pressure regulator contributes to ranges of low strength spray mist, intermediate strength spray mist and higher strength spray mist cleaning.

12. The cleaning station process according to claim 11, wherein the droplet size is selected from a group of droplet sizes consisting of having the low strength spray mist, the intermediate strength mist and the higher strength mist, depending on a size of ejected solvent particles.
